(19) United States
(12) Patent Application Publication
(10) Pub. No.: US 2021/0295333 A1
(43) Pub. Date: Sep. 23, 2021

(54) LOW-POWER DEVICE AND METHOD FOR PERFORMING TRANSACTION AT MERCHANT LOCATION DURING POWER-CRISIS AT MERCHANT LOCATION

(71) Applicant: TOSHIBA TEC KABUSHIKI KAISHA, Tokyo (JP)

(72) Inventors: Krishna PUTHRAN, Bangalore (IN); Santosh KUMBAR, Bangalore (IN)

(73) Assignee: TOSHIBA TEC KABUSHIKI KAISHA, Tokyo (JP)

(21) Appl. No.: 17/103,718

(22) Filed: Nov. 24, 2020

(30) Foreign Application Priority Data
Mar. 18, 2020 (IN) 202041011567

(51) Int. Cl. G06Q 20/40; G06Q 40/02; G06Q 30/02; G06Q 20/08; G06Q 10/08; G06Q 20/20

(52) U.S. Cl. CPC G06Q 20/403; G06Q 40/025; G06Q 30/0236; G06Q 30/0233; G06Q 20/085; G06Q 30/0238; G06Q 20/4014; G06Q 20/202; G06Q 20/203; G06Q 20/204; G06Q 10/087

(57) ABSTRACT

A device for performing a transaction at a merchant location during a power-crisis at the merchant location is configured to receive information from a customer for performing a current transaction. The device is configured to compare the information with backup data accessible by the device to authenticate the customer. The backup data includes minimal information regarding customer including (i) customer name and/or contact details, (ii) credit points associated with customer, and (iii) security information associated with customer. Thereafter, the device is configured to retrieve the credit points associated with customer from the backup data. The device is configured to deduct used credit points based on a purchase amount and update the backup data. When there is access to a power source, the device is configured to connect to a server to facilitate initiating a settlement process with a financial institution and/or notifying the customer to clear dues with a merchant.

### CROSS-REFERENCE TO RELATED PATENT APPLICATION

This application is based upon and claims the benefit of priority from Indian Patent Application No. 2020-41011567, filed Mar. 18, 2020, the entire contents of which are incorporated herein by reference.

### TECHNICAL FIELD

The present subject matter generally relates to a low-power computing device for payment transactions. More particularly, but not exclusively, the present disclosure discloses a method and a low-power computing device for performing a transaction at a merchant location during a power-crisis at the merchant location.

### BACKGROUND

When a natural disaster occurs such as earthquake, typhoon, hurricane, or flood there may be electricity power shortage or crisis in such areas. In such situations, Point of Sale (POS) devices or payment devices may not work and hence may be difficult for retail stores to perform any transaction. Also, customers or users may not have enough cash or a credit card or even a smartphone to buy items from the retail stores.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of performing a transaction at a merchant location during a power-crisis at the merchant location. The method comprises receiving, by a low-power computing device, personal information and security information from a customer for performing a current transaction. The method further comprises authenticating the customer by comparing the personal information and the security information with backup data in a memory unit accessible by the low-power computing device. The backup data stores minimal information of the customer comprising (i) the personal information including a customer name and/or contact details, (ii) credit points associated with the customer, and (iii) the security information associated with the customer. Thereafter, the method comprises retrieving the credit points associated with the customer from the backup data of the customer. Further, the method comprises performing the current transaction using the credit points.

Further, the present disclosure discloses a low-power computing device for performing a transaction at a merchant location during a power-crisis at the merchant location. The low-power computing device comprises a processor and a memory unit communicatively coupled to the processor. The memory unit stores processor-executable instructions, which, on execution, causes the processor to receive personal information and security information from a customer for performing a current transaction. The processor authenticates the customer by comparing the personal information and the security information with backup data in the memory unit, where the backup data stores minimal information of the customer comprising (i) the personal information including a customer name and/or contact details, (ii) credit points associated with the customer, and (iii) the security information associated with the customer. Thereafter, the processor retrieves the credit points associated with the customer from the backup data of the customer. Once the credit points are retrieved, the processor performs the current transaction using the credit points.

Further the present disclosure comprises a non-transitory computer readable medium including instructions stored thereon that when processed by at least one processor causes the processor to perform a transaction at a merchant location during a power-crisis at the merchant location. Further, the instructions cause the processor to receive personal information and security information from a customer for performing a current transaction. Furthermore, the instructions cause the processor to authenticate by comparing the personal information and the security information with backup data in a memory unit accessible by the low-power computing device wherein the backup data stores minimal information of the customer comprising (i) the personal information including a customer name and/or contact details, (ii) credit points associated with the customer, and (iii) the security information associated with the customer. Further, the instructions cause the processor to retrieve the credit points associated with the customer from the backup data of the customer. Finally, the instructions cause the processor to perform, the current transaction using the credit points.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for performing a transaction at a merchant location in accordance with some embodiments of the present disclosure.

FIG. 2 shows a block diagram of a low-power device in accordance with some embodiments of the present disclosure.

FIG. 3 shows a flowchart illustrating a method for performing a transaction at a merchant location during a power-crisis at the merchant location in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a low-power computing device for performing a transaction at a merchant location during a power-crisis at the merchant location. As an example, there may be power crisis at the merchant location and hence it may be difficult for the merchants to perform any payment transaction. Therefore, the present disclosure discloses a low-power computing device which may be used in such situations for performing the transactions. The low-power computing device (also referred to herein as device) may be a device which consumes less battery power than a traditional POS device. The device may receive personal information and security information from a customer for performing a current transaction. The security information may be provided by the customer during initial registration of the customer with the merchant. The device may compare the personal information and the security information with backup data of the device for authenticating the customer. The backup data stores minimal information of the customer such as (i) customer name, contact details, and/or credit points associated with the customer and (ii) the security information associated with the customer. Thereafter, the device may retrieve credit points associated with the customer from the backup data of the customer once the customer is authenticated. The credit points may be earned by the customer based on history of transaction of the customer with the merchant. The device may perform the transaction using the credit points where the device may update purchase amount of the current transaction in the backup data. The device may also deduct the credit points based on the purchase amount and update the same in the backup data. When there is access to power source, the device may be connected to server and the server may retrieve purchase amount and customer details, and initiates a process to do settlement with financial institution or notifies the customer to clear off dues as per the process set by the merchant. Therefore, in the present disclosure, even during power crises, the merchant can make transaction with the customer using the low-power computing device. The low-power computing device may be the one which has basic input device to receive input data and has a processor which can access the input data, compare with data in memory unit and store the input data in the memory. The low-power computing device may be the one with less user interface and the display interface may be of an LCD display.

In the following detailed description of the embodiments of the disclosure, reference is made to the accompanying drawings that form a part hereof, and in which are shown by way of illustration of embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

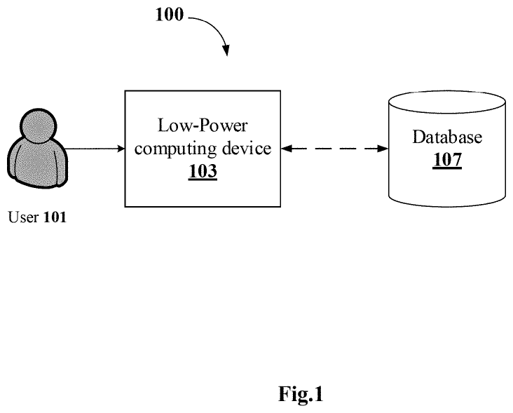

FIG. 1 illustrates an exemplary environment for performing a transaction at a merchant location in accordance with some embodiments of the present disclosure.

The environment 100 may comprise a user or a customer 101, a low-power computing device 103, and a database 107 (or server). The low-power computing device 103 (also referred to herein as device 103) may be any computing device which consumes less power than a traditional POS device. The device 103 may be provided with a battery as a power-source. In an embodiment, the device 103 may be provided to a merchant where the merchant may perform transactions using the device 103 which consumes less power. The device 103 may be associated with a memory unit (memory). The memory unit comprises backup data. The backup data stores minimal information of one or more customers who wish to perform transactions at the merchant such as (i) customer name, contact details, and/or credit points associated with the customer 101 and (ii) security information associated with the customer 101. Since, the device 103 stores minimal information, the device 103 consumes less storage space. The credit points may be provided by the merchant based on historic transactions of the customer 101 with the merchant. The device 103 may receive personal information and security information from a customer 101 when the customer 101 wishes to perform a transaction for buying any product from the merchant. The personal information may include customer name, contact details and credit points associated with the customer 101 and the security information. As an example, the security information may include a security password provided by the customer 101 during initial registration of the customer 101 with the merchant. Upon receiving the personal information and the security information, the device 103 may authenticate the customer 101 by comparing the received personal information and the security information with the backup data. If the received personal information and the security information matches with the backup data of the customer 101 stored in the memory unit, then the device 103 may authenticate the customer 101. Once the customer 101 is authenticated, the device 103 may retrieve credit points associated with the customer 101. The credit points may be earned by the customer 101 based on history of transactions of the customer 101 with the merchant. If the customer 101 has made a greater number of transactions with the merchant, then the credit points earned by the customer 101 may also be more. In an embodiment, the credit points may also be earned based on guarantee provided by a financial institution such as a bank for payment transactions by the customer 101. Upon retrieving the credit points, the device 103 may perform the current transaction using the credit points by updating purchase amount of the current transaction in the backup data. The device 103 may also deduct the credit points based on the purchase amount and update the same in the backup data. When there is access to power source, the device 103 may be connected to a server and the server may retrieve transaction details including purchase amount and customer details, and initiates a process to do settlement with financial institution or notifies the customer to clear off dues as per the process set by the merchant. In one embodiment, the server may update inventory based on the purchase. In another embodiment, once there is access to the power source, the device 103 may perform the transaction by updating information associated with the purchase amount for the current transaction in the database 107 and also deduct the credit points for the purchase amount and update the credit points in the database 107.

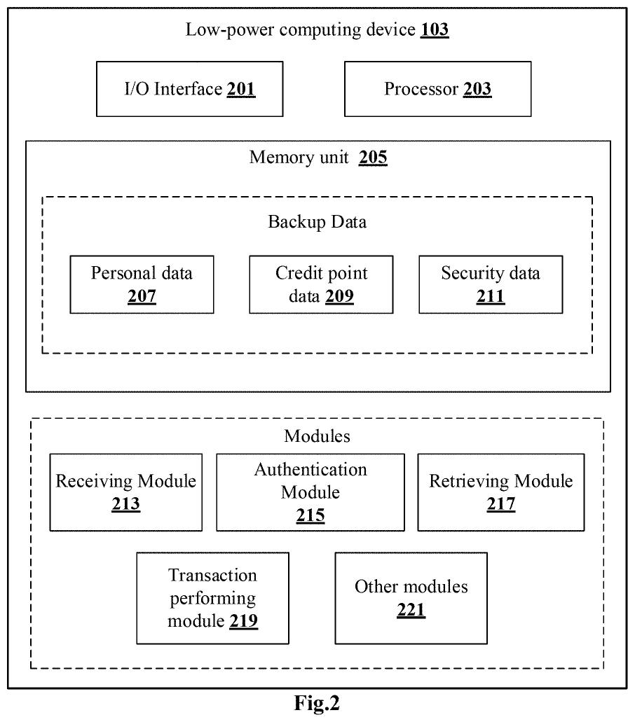

FIG. 2 shows a block diagram of a low-power device in accordance with some embodiments of the present disclosure.

As shown in FIG. 2, the device 103 may comprise an input/output (I/O) interface 201, a processor 203 and a memory unit 205 (memory). The I/O interface 201 may be configured to receive personal information and security information from the user 101. The processor 203 may be configured to perform one or more functions of the device 103. In some implementations, the device 103 may include backup data and modules for performing various operations in accordance with embodiments of the present disclosure. In an embodiment, the backup data may be stored within the memory unit 205 and may include, without limiting to, personal data 207, credit point data 209, and security data 211. The data is backed-up from the database 107 at regular intervals or before the power crises into the memory unit 205.

In some embodiments, the backup data may be stored within the memory unit 205 in the form of various data structures. Additionally, the backup data may be organized using data models, such as relational or hierarchical data models.

In an embodiment, one or more modules may process the data of the device 103. In one implementation, the one or more modules may be communicatively coupled to the processor 203 for performing one or more functions of the device 103. The modules may include, without limiting to, a receiving module 213, an authentication module 215, a retrieving module 217, transaction performing module 219, and other modules 221.

As used herein, the term module refers to an Application Specific Integrated Circuit (ASIC), an electronic circuit, a processor 203 (shared, dedicated, or group), and memory unit 205 that execute one or more software or firmware programs, a combinational logic circuit, and/or other suitable components that provide the described functionality. In an embodiment, the other modules 221 may be used to perform various miscellaneous functionalities of the device 103. It will be appreciated that such modules may be represented as a single module or a combination of different modules. Furthermore, a person of ordinary skill in the art will appreciate that in an implementation, the one or more modules may be stored in the memory unit 205, without limiting the scope of the disclosure. The modules when configured with the functionality defined in the present disclosure will result in a novel hardware.

In an embodiment, the receiving module 213 may be configured to receive personal information and security information from a customer 101 for performing a current transaction. The personal information may include, but not limited to, customer name and contact details of the customer 101. The security information may include a security password. The personal information may be stored as personal data 207 and the security information may be stored as security data 211.

In an embodiment, the authentication module 215 may be configured to authenticate the customer 101 for performing the transaction. The authentication may be performed by comparing the received personal data 207 with the backup data stored in the memory unit 205. In an embodiment, the backup data stores minimal information of the customer 101 such as personal information of one or more customers, security information of one or more customers, and credit points associated with the one or more customers. When the received personal information and the security information matches with the customer information stored in the backup data, the authenticating module authenticates the customer 101.

Once the customer 101 is authenticated, the retrieving module 217 may be configured to retrieve the credit points associated with the customer 101. As an example, the credit points associated with the customer 101, “customer A” may be 2000 points. In an embodiment, the credit points may be provided to the customer 101 based on historic transactions of the customer 101 with the merchant. In another embodiment, the credit points may be earned by the customer 101 based on history of transactions guarantee provided by a financial institution for payment transactions of the customer 101. The credit points associated with the customer 101 may be stored as credit point data 209.

In an embodiment, the transaction performing module 219 may be configured to perform the transaction using the credit points by updating purchase amount of the current transaction in the backup data. As an example, the purchase amount may be $50. The amount would be updated in the backup data and based on the purchase amount the credit points may be deducted and updated in the backup data. When there is access to power source, the device 103 may be connected to a server and the server may retrieve transaction details including purchase amount and customer details, and initiate a process to do settlement with financial institution or notifies the customer to clear off dues as per the process set by the merchant.

### Exemplary Scenario

As an example, “customer A” may buy a product from merchant X. The amount associated with the product may be $50. At the time of payment, the customer 101 may be requested to provide personal information and security information. The personal information may be customer name or contact details. The security information may be a unique security password. The “customer A” provides customer name and security information. The customer name and the security information provided may be as “customer A” and “XYZ” respectively. Upon receiving this information, the device 103 at the merchant authenticates the “customer A” by comparing the received personal information and the security information with the backup data stored in a memory unit 205 associated with the device 103. The exemplary backup data is as shown in below Table 1. The backup data may store details of one or more customers such as “customer A”, “customer B”, “customer C”, and “customer D” as indicated in Table 1.

TABLE 1

| | | Security | |
|---|---|---|---|
| Customer Name | Contact Details | Information | Credit Points |
| Customer A | 9663621058 | XYZ | 5000 |
| Customer B | 9764621308 | ABC | 4000 |
| Customer C | 9643624058 | DEL | 3000 |
| Customer D | 9763621108 | SET | 5000 |

Since the details provided by the “customer A” matches with the details stored in the backup data for the “customer A”, the customer 101 is authenticated, and the device 103 retrieves credit points associated with the customer 101 from the backup data. As an example, the credit points associated with “customer A” is 5000 points. Once the “customer A” is authenticated, the “customer A” may be provided with the product. Thereafter, the device 103 may perform the transaction by updating the purchase amount in the backup data as shown in below Table 2 and may also deduct the credit the points for the purchase amount and update the same in the backup data as shown in Table 3. As an example, 1000 credit points may be deducted for $50. The conversion from the credit points to currency may be decided by the merchant based on disaster conditions, trust factor with the customer 101, and/or credit risk factor.

TABLE 2

| | | Security | | Purchase |
|---|---|---|---|---|
| Customer Name | Contact Details | Information | Credit Points | Amount |
| Customer A | 9663621058 | XYZ | 5000 | $50 |
| Customer B | 9764621308 | ABC | 4000 | — |
| Customer C | 9643624058 | DEL | 3000 | — |
| Customer D | 9763621108 | SET | 5000 | — |

TABLE 3

| | | Security | | Purchase |
|---|---|---|---|---|
| Customer Name | Contact Details | Information | Credit Points | Amount |
| Customer A | 9663621058 | XYZ | 4000 | $50 |
| Customer B | 9764621308 | ABC | 4000 | — |
| Customer C | 9643624058 | DEL | 3000 | — |
| Customer D | 9763621108 | SET | 5000 | — |

In an embodiment, once the merchant has access to the power source, the device 103 may be connected to a server and the server may retrieve transaction details including purchase amount and customer details, and initiates a process to do settlement with financial institution or notifies the customer to clear off dues as per the process set by merchant.

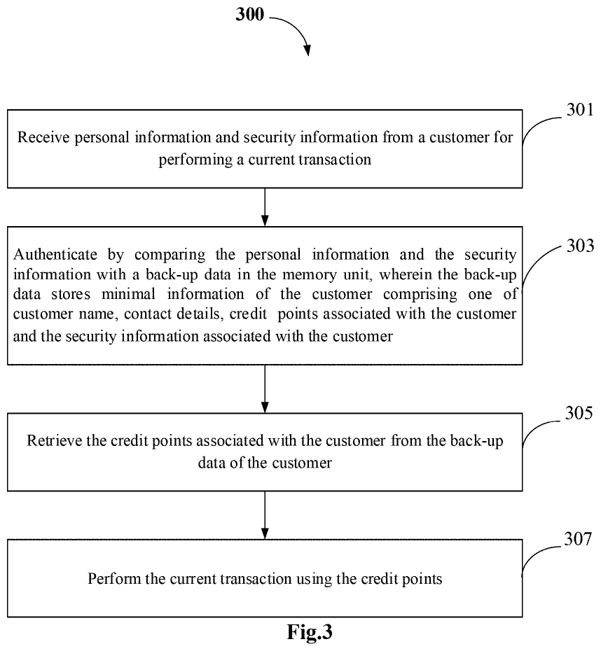

FIG. 3 shows a flowchart illustrating a method for performing a transaction at a merchant location during a power-crisis at the merchant location in accordance with some embodiments of the present disclosure.

As illustrated in FIG. 3, the method 300 comprises one or more blocks for performing a transaction at a merchant location during a power-crisis at the merchant location using the low-power computing device 103. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method 300 may comprise receiving personal information and security information from a customer 101 for performing a current transaction. The personal information may include a name and/or contact details of the customer 101. The security information may be a unique password provided by the customer 101 or supplied by the merchant during initial registration of the customer 101 with the merchant. In one embodiment the security information could be any information which the merchant may have access, which can be used for authenticating the customer 101.

At block 303, the method may comprise authenticating the customer 101 for performing the current transaction. The authentication may be performed by comparing the personal information and the security information with backup data in a memory unit 205 accessible by the low-power computing device 103. The backup data stores customer name, contact details, and/or credit points associated with one or more customers. When the personal information and the security information match with the backup data of the customer 101, the customer 101 may be authenticated.

At block 305, the method 300 may comprise retrieving the credit points associated with the customer 101 from the backup data of the customer 101. The credit points may be retrieved from the backup data.

At block 307, the method 300 may comprise performing the current transaction using the credit points. In an embodiment, the current transaction may be performed by updating purchase amount and deducting credit points for the purchase amount of the current transaction in the backup data. When there is access to the power source, the device 103 may be connected to a server and the server may retrieve transaction details including purchase amount and customer details, and initiates a process to do settlement with financial institution or notifies the customer to clear off dues as per the process set by the merchant.

### Advantages of Present Disclosure

In an embodiment, the present disclosure provides a method and a low-power device for performing a transaction at a merchant location during a power-crisis at the merchant location.

In an embodiment, the present disclosure discloses a low-power device which stores minimal data of customers in its back up data and hence consumes less storage space.

In an embodiment, the present disclosure enables users or customers to perform transactions using credit points provided by a merchant during a power-crisis.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference Number | Description |
|---|---|
| 100 | Environment |
| 101 | User |
| 103 | Low-power computing device |
| 107 | Database |
| 201 | I/O Interface |
| 203 | Processor |
| 205 | Memory Unit |
| 207 | Personal data |
| 209 | Credit point data |
| 211 | Security data |
| 213 | Receiving module |
| 215 | Authentication module |
| 217 | Retrieving module |
| 219 | Transaction performing module |
| 221 | Other modules |

What is claimed is:

1. A method for performing a transaction at a merchant location during a power-crisis at the merchant location, the method comprising:
receiving, by a low-power computing device, information from a customer for performing a current transaction;
authenticating, by the low-power computing device, the customer by comparing the information with backup data in a memory accessible by the low-power computing device, wherein the backup data includes minimal information regarding the customer comprising (i) personal information including at least one of a customer name or contact details, (ii) credit points associated with the customer, and (iii) security information associated with the customer;
retrieving, by the low-power computing device, the credit points associated with the customer from the backup data in response to the information received from the customer corresponding to the personal information and the security information in the backup data; and
performing, by the low-power computing device, the current transaction using the credit points.

2. The method of claim 1, wherein the credit points are earned based on a history of transactions of the customer with a merchant.

3. The method of claim 1, wherein the credit points are earned based on a guarantee provided by a financial institution regarding payment of transactions of the customer.

4. The method of claim 1, wherein the credit points are earned based on (i) a guarantee provided by a financial institution regarding payment of transactions of the customer and (ii) a history of transactions of the customer with a merchant.

5. The method of claim 1, wherein the security information is provided by a merchant to the customer during initial registration of the customer with the merchant.

6. The method of claim 1, wherein performing the current transaction during the power crisis comprises updating a purchase amount and deducting used credit points associated with the purchase amount of the current transaction in the backup data.

7. The method of claim 1, wherein performing the current transaction comprises providing, by the low-power computing device when connected to an external power source, transaction details regarding the current transaction to a server associated with the low-power computing device.

8. The method of claim 7, further comprising initiating, by the server, a settlement process with a financial institution associated with the customer based on the transaction details.

9. The method of claim 7, further comprising providing, by the server, a notification to the customer to clear dues with a merchant based on the transaction details.

10. The method of claim 7, further comprising downloading, by the low-power computing device, the backup data from the server prior to the power-crisis.

11. The method of claim 7, further comprising updating, by the server, inventory of a merchant based on the transaction details.

12. The method of claim 1, wherein the low-power computing device includes a battery.

13. A low-power computing device for performing a transaction at a merchant location during a power-crisis at the merchant location, the low-power computing device comprising:
one or more processors; and
a memory having instruction stored thereon that, when executed by the one or more processors, cause the one or more processors to:
receive information from a customer for performing a current transaction;
authenticate the customer by comparing the information with backup data in the memory, wherein the backup data includes minimal information regarding the customer comprising (i) personal information including at least one of a customer name or contact details, (ii) credit points associated with the customer, and (iii) security information associated with the customer;
retrieve the credit points associated with the customer from the backup data in response to the information received from the customer corresponding to the personal information and the security information in the backup data; and
perform the current transaction using the credit points.

14. The low-power computing device of claim 13, wherein the credit points are earned based on at least one of (i) a history of transactions of the customer with a merchant or (ii) a guarantee provided by a financial institution regarding payment of transactions of the customer.

15. The low-power computing device of claim 13, wherein the instructions cause the one or more processors to perform the current transaction during the power crisis by updating a purchase amount and deducting used credit points associated with the purchase amount of the current transaction in the backup data.

16. The low-power computing device of claim 13, wherein the instructions cause the one or more processors to perform the current transaction by providing transaction details regarding the current transaction to a server associated with the low-power computing device when connected to an external power source to facilitate at least one of (i) initiating a settlement process with financial institution or (ii) providing a notification to the customer to clear dues with a merchant based on the transaction details.

17. A non-transitory computer-readable storage medium having instructions stored thereon that, upon execution by at least one processor, cause the at least one processor to:
receive information from a customer for performing a current transaction;
authenticate the customer by comparing the information with backup data stored in the non-transitory computer-readable storage medium, wherein the backup data includes minimal information regarding the customer comprising (i) personal information including at least one of a customer name or contact details, (ii) credit points associated with the customer, and (iii) security information associated with the customer;
retrieve the credit points associated with the customer from the backup data in response to the information received from the customer corresponding to the personal information and the security information in the backup data; and
perform the current transaction using the credit points.

18. The non-transitory computer-readable storage medium of claim 17, wherein the credit points are earned based on at least one of (i) a history of transactions of the customer with a merchant or (ii) a guarantee provided by a financial institution regarding payment of transactions of the customer.

19. The non-transitory computer-readable storage medium of claim 17, wherein the instructions cause the at least one processor to perform the current transaction during the power crisis by updating a purchase amount and deducting used credit points associated with the purchase amount of the current transaction in the backup data.

20. The non-transitory computer-readable medium of claim 17, wherein the instructions cause the at least one processor to perform the current transaction by providing transaction details regarding the current transaction to a server when connected to an external power source to facilitate at least one of (i) initiating a settlement process with financial institution or (ii) providing a notification to the customer to clear dues with a merchant based on the transaction details.
